(19) United States
(12) Patent Application Publication
(10) Pub. No.: US 2009/0190492 A1
(43) Pub. Date: Jul. 30, 2009

(54) Header Estimation To Improve Multimedia Quality Over Wireless Networks

(75) Inventors: Syed Ali Khayam, East Lansing, MI (US); Shirish Karande, Santa Cruz, CA (US); Hayder Radha, East Lansing, MI (US)

Correspondence Address: HARNESS, DICKEY & PIERCE, P.L.C., P.O. BOX 828, BLOOMFIELD HILLS, MI, 48303, US

(73) Assignee: THE BOARD OF TRUSTEES OF MICHIGAN STATE UNIVERSITY, East Lansing, MI (US)

(21) Appl. No.: 12/362,055

(22) Filed: Jan. 29, 2009

Related U.S. Application Data
(60) Provisional application No. 61/062,929, filed on Jan. 30, 2008.

(51) Int. Cl. H04L 12/26

(52) U.S. Cl. 370/252

(57) ABSTRACT

A method is provided for estimating the header of a data packet in a wireless communication system. The method includes: maintaining a list of data packets received without an error at a receiver; receiving at the receiver a corrupt data packet having errors in its header; computing a likelihood score for the header of the corrupt data packet in relation to each entry in the list of data packets; and selecting an entry having the highest likelihood score as an estimated header for the corrupt data packet.

### CROSS-REFERENCE TO RELATED APPLICATIONS

This application claims the benefit of U.S. Provisional Application No. 61/062,929 filed on Jan. 30, 2008. The disclosure of the above application is incorporated herein by reference.

### FIELD

The present disclosure relates to a method for estimating headers of corrupt data packets in a wireless communication system.

### BACKGROUND

Wireless communication channels incur unpredictable and time-varying packet-losses due to fading, interference, and mobility. This data loss is particularly detrimental for real-time communications whose delay constraints generally do not allow retransmission-based recovery of lost packets. To combat wireless errors and losses, emerging multimedia standards have introduced enhanced error-resilience and concealment features, e.g., slices in JVT/H.264 and reversible VLC in MPEG-4. For an error-resilient application, distortion in multimedia quality can be decreased by reducing the amount of data loss at a wireless receiver, i.e., by relaying maximum number of error-free and corrupted packets to the multimedia application. It is then up to the application to drop or retain the corrupted packets.

Due to the high error-rates of wireless media, many errors are not corrected by the physical layer. These errors cause checksum failures at higher layers, consequently leading to a significant number of packet drops on a link employing a conventional (e.g., TCP-UDP/IP) protocol stack. Previous wireless multimedia studies proposed to reduce packet drops by employing a partial checksum which only covers packets' headers while payload errors are ignored. Payload errors are subsequently corrected using forward error correction (FEC) at the application layer. It has been shown that partial protection with FEC requires much less FEC redundancy than a conventional protocol stack that drops corrupted packets. However, schemes using partial checksum incur packet drops due to header errors, especially at high data rates. Also, support of partial checksum requires changes to the standard protocols at the multimedia transmitter and/or intermediate network nodes. In many realistic scenarios, modifications to multimedia servers and intermediate nodes cannot be dictated by the end-receivers.

The statements in this section merely provide background information related to the present disclosure and may not constitute prior art.

### SUMMARY

A method is provided for estimating the header of a data packet in a wireless communication system. The method includes: maintaining a list of data packets received without an error at a receiver; receiving at the receiver a corrupt data packet having errors in its header; computing a likelihood score for the header of the corrupt data packet in relation to each entry in the list of data packets; and selecting an entry having the highest likelihood score as an estimated header for the corrupt data packet.

Further areas of applicability will become apparent from the description provided herein. It should be understood that the description and specific examples are intended for purposes of illustration only and are not intended to limit the scope of the present disclosure.

### DRAWINGS

FIG. 1 is a flowchart illustrating a proposed method for estimating a corrupt header of a data packet in a wireless communication system;

FIG. 2 is a diagram depicting interactions between a header estimation module and different layers of a wireless receiver's protocol stack;

FIG. 3 is an exemplary simulation setup used to test the proposed method;

FIGS. 4A and 4B are graphs illustrating throughputs at 2 Mbps of global and local variants of the proposed method, respectively;

FIGS. 5A and 5B are graphs illustrating throughputs at 5.5 Mbps of global and local variants of the proposed method, respectively;

FIGS. 6A and 6B are graphs illustrating throughputs at 11 Mbps of global and local variants of the proposed method, respectively;

FIGS. 7A and 7B are graphs illustrating throughputs with skewed source distributions at 5.5 Mbps and 11 Mbps, respectively;

FIGS. 8A and 8B are graphs illustrating FEC performance of global and local variants, respectively

The drawings described herein are for illustration purposes only and are not intended to limit the scope of the present disclosure in any way.

### DETAILED DESCRIPTION

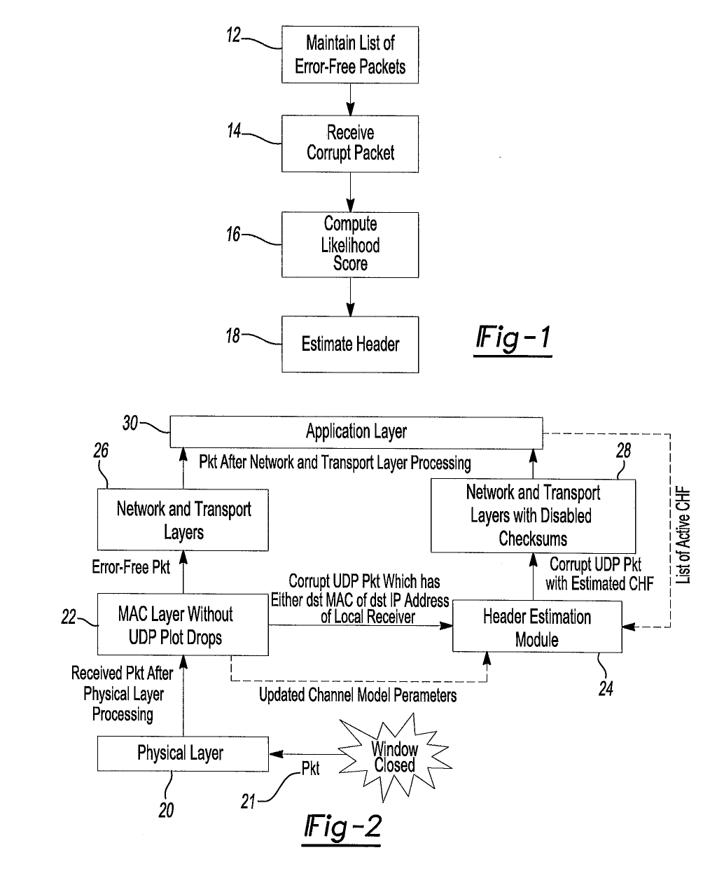

FIG. 1 illustrates a proposed method for estimating a header of a corrupt data packet in a wireless communication system. Header estimation estimates the critical header fields (CHF) that can uniquely classify a multimedia session at the receiver and are not liable to change during a multimedia transmission. In an exemplary embodiment, these CHF may include: destination MAC address, source and destination IP addresses, and source and destination ports. More or less fields (including the entirety of the header) can be concatenated to these CHF without any modifications to the proposed methodology. Thus, all mathematical treatment is provided for a general case of N critical fields.

In the proposed methodology, a list of data packets recently received without an error is maintained at 12 by the receiver. In an exemplary embodiment, the list is of active CHF (i.e., CHF of sessions that are currently being received) and may be provided to a header estimation module by the multimedia application(s) residing on the receiver. Upon receiving the first error-free packet of a new session, the multimedia application adds the new session's information to the list of active multimedia sessions. Whenever a corrupted packet is received, a likelihood score of its critical fields is computed at 16 with respect to each entry of the CHF list. The CHF rendering the highest likelihood are chosen at 18 as the estimated CHF of the received (corrupted) packet. The main objection of header detection is to relay maximum number of packets to a wireless receiver's application layer.

FIG. 2 outlines the interactions between a header estimation module implementing the proposed method and different layers of a wireless receiver's protocol stack. After wireless physical layer processing, the packets 21 are passed to the MAC layer 22 which verifies the packet's checksum to determine if the received packet has errors. Instead of dropping a corrupted packet, the packet and its checksum information (i.e., packet passed/failed the checksum) is passed to a module that checks the transport type, the destination MAC address, and the destination IP address of the received packet. In an exemplary embodiment, header estimation is invoked at 24 only for UDP packets, while TCP and network layer traffic are handled by the conventional protocol stack. Furthermore, the MAC layer does not attempt retransmission-based recovery of corrupt UDP packets, i.e., ACKs are sent even for corrupt UDP packets. Instead of MAC retransmissions, header estimation with application layer FEC is used to recover from errors in the packet. Such retransmission-less recovery is well-suited for delay-sensitive real-time communications.

Header estimation is invoked when all of the following conditions are satisfied: (i) a corrupt UDP packet is received, (ii) either the destination MAC or the destination IP address matches the local receiver's addresses, and (iii) there are one or more active multimedia sessions on the receiver. Three scenarios exist when a packet is received:
1) Packet is error-free: No need to perform header estimation.
2) Packet is corrupt and the packet is intended for the local receiver: Header estimation is invoked and an ACK is sent to the last hop network entity to avoid MAC layer retransmissions.
3) Packet is corrupt and the packet is not intended for the local receiver: This case represents a false alarm when, due to channel errors, either destination MAC or destination IP of a packet not intended for the local receiver gets mapped to the MAC or IP address of a receiver. Due to the receiver-based nature of the present scheme, false alarms cannot be detected at a receiver's MAC layer. Thus, header estimation is invoked even for false alarm packets and a MAC layer ACK is sent to the last hop network entity.

The header estimation module employs a likelihood function to find the most likely transmitted CHF given the received CHF and a list of active CHF. The list of active CHF is provided by the receiver's application layer. The transmitted/active CHF that renders the maximum value of the likelihood function is chosen as the estimated CHF. The corrupt packet and the estimated CHF are passed to higher layers 28-30. In essence, the present header estimation problem is the estimation-theoretic problem of maximum-likelihood (ML) estimation of known parameters in noise. Further details regarding the estimation techniques employed by the header estimation module are provided below.

The corrupted packets along with the estimated CHF are passed by the header estimation module to the receiver's network layer. The network layer performs its regular operation with two modifications: (a) instead of the (possibly corrupted) IP addresses in the network layer header, the estimated IP addresses are treated as the true IP addresses; (b) network layer checksum on IP headers is disabled. At the UDP layer, source and destination posts are taken from the estimated CHF and the corrupted packets are passed to the (estimated) multimedia application.

Let W denote the CHF of a received packet and let [symbol] ={X₁, X₂, . . . , Xₙ} be the set of distinct correctly received CHF of the last E multimedia packets. That is, each Xᵢε [symbol] for 1≦i≦n, represents the CHF of session i. The set [symbol] =Uᵢ₌₁ⁿXᵢ, the set of all bins of the histogram, constitutes the sample space of the a priori CHF distribution. The a posteriori distribution of the received CHF can then be expressed as

$$P ( {X}_{i} \vert W ) = \frac{P ( W \vert {X}_{i} ) P ( {X}_{i} )}{{\sum }_{j = 1}^{n} P ( W \vert {X}_{j} ) P ( {X}_{j} )} \qquad ( 1 )$$

where P(Xᵢ) represents the a priori probability of CHF Xᵢ and the conditional probability terms, P(W|Xᵢ)'s, represent the likelihood function. The a posteriori distribution renders the probability that while the received CHF is W, the actual transmitted CHF was Xᵢ. Once the a posteriori distribution is ascertained, the present header detection problem corresponds to the problem of multihypothesis detection of known parameters in noise, with CHF of the multimedia sessions representing the hypotheses under consideration. The classical detection problem concludes with each of the hypotheses being scored as detected or undetected. In this work, the detected CHF is used as an estimate of the transmitted fields to perform further packet processing. Thus, the present problem can also be viewed as an estimation-theoretic problem. The following sections explain the computation of the a priori distribution and the likelihood function.

Under the proposed approach, a multimedia receiver maintains a list of data packets recently received without error. In an exemplary embodiment, the list may be a histogram based on previously-received error-free packets. Normalizing this histogram renders a robust a priori distribution of active wireless sessions. The CHF histogram can be generated either using the error-free packets that were destined for the local receiver or, due to the broadcast nature of wireless networks, using the error-free packets destined for any node on the wireless network. This notion will be used later to define two variants of the proposed technique.

It should be noted that the present strategy does not characterize the complete prior information. Let A and B represent two events corresponding to the reception of an error-free and a corrupted packet, respectively. The method may include only computing a probability for event A, but the complete P(Xᵢ) is given by P(Xᵢ)=P(Xᵢ|A)P(A)+P(Xᵢ|B)P(B). Probabilities involving event B can be computed only if the transmitter or an intermediate node at the edge of the wired channel protects the CHF using FEC. Such a strategy, however, requires modifications to the transmitter or intermediate nodes, thereby defying one of the premises of this work. The simulation results show that the header detectors employing the partial priors (based only on event A) incur negligible errors, implying that the partial priors provide a good estimate of the complete priors.

Since the possible values of the active CHF from the sample space of the a priori distribution are known, a likelihood function is proposed to exploit this knowledge. A memory-less channel with a fixed probability of bit-error, p may be assumed. While the assumption of a memory-less channel is somewhat unrealistic, a model with memory may be employed if some side-information renders real-time channel prediction and characterization. In the absence of good channel characterization, the memory-less channel assumption is a pragmatic alternative. It should be noted though that, while the proposed methodology relies on the memory-less premise, the error traces used for the simulations discussed below were collected over an actual 80211b network under realistic settings. The memory-less assumption, hence, provides a lower bond on the achievable performance. A blind and fixed estimate of p is used for the experiments.

The Hamming distance between Wand Xᵢ is used to calculate the conditional likelihood probability, P(W|Xᵢ), for a given Xᵢ. The Hamming distance will indicate the total number of bits that are different between W and Xᵢ Assuming that the different bits are in fact the bit-errors introduced by the memory-less channel, then P(W|Xᵢ) may be written as

P(W|Xᵢ)=p^{hd(W,X}^{ᵢ}⁾(1−p)^{L-hd(W,X}^{ᵢ}⁾ (2)

where L is the length of the CHF in bits, and the function hd(a,b) is the Hamming distance between bit sequences a and b. The expression given in (2) renders the probability that Xᵢ was transmitted CHF which, due to the channel bit-errors, was received as W. The a posteriori density on which different detectors can be applied is obtained by plugging (2) in (1).

Lastly, a determination is made from the a posteriori distribution as to an estimated header for the incoming data packet. Two exemplary detectors may be applied on the a posteriori distribution: an approximate maximum a posteriori detector and a rounded mean a posteriori detector. Approximate maximum detector (AxMAP) selects the mode (i.e., the most likely Xᵢ) of the a posteriori density P(X|W) as the detected CHF. This detector may be referred to as an approximation of the well-known MAP detector because i) it operates in the discrete domain, and hence does not retain the optimality properties of the MAP detector and ii) in the present setup, the a priori distribution is based on partial priors.

The rounded mean detector (RMeAP) selects the mean of the a posteriori density, P(X|W), rounds it to the nearest CHF value, and uses that value as the detected CHF. The CHF of each multimedia session may be mapped to a distinct integer value. Thus, the mapping yields X₁→1, X₂→2, . . . , Xₙ→n. The mean is computed using the mapped value, {1, 2, . . . n}, as the outcomes of the random variable X. Once the mean is computed and rounded, the resultant integer value, say i, may be mapped back to its corresponding CHF, Xᵢ. Other types of detectors are also contemplated by this disclosure.

Two variants of the proposed scheme are contemplated. A global statistics variant (GSV) exploits the broadcast nature of wireless networks. The a priori CHF distribution is generated using all the error-free packets on the wireless network, and not necessarily the packets that were destined for a particular receiver. Thus, each promiscuous node in the wireless network maintains a CHF histogram from packets that it correctly receives.

In a local statistics variant (LSV), the CHF histogram is computed using packets that are destined for the local wireless node. In the LSV, a receiver first reads the destination MAC and destination IP addresses of a received packet. Header detection is initiated if at least one of these addresses is the local node's address. The LSV will be effective in secure wireless networks where packet header information is encrypted to curb network sniffing. Furthermore, LSV requires lesser processing and data maintenance overhead than GSV, which is a very important consideration for complexity- and power-constrained wireless receivers.

It is noteworthy that, in addition to wrong detections, LSV experiences missed packets where both the destination MAC and IP addresses are corrupted, and thus detection is not attempted. Also, the prior information for LSV is not as robust as GSV. It may be expected that LSV performs worse than GSV. On the contrary, it may be shown that at most data rates LSV's performance is comparable to GSV. Hence, LSV provides an accurate, effective and low complexity alternative to GSV.

802.11b MAC layer bit-error traces are used to simulate the wireless channel. The bit-error traces were collected at 2, 5.5, and 11 Mbps data rates of an operational 802.11b wireless LAN under realistic settings. It has been shown that the bit-error rate at the 802.11 MAC layer is directly proportional to the data rate at which the wireless network is operating. This observation will be emphasized in the subsequent performance evaluation sections of this paper. Reference may be made to S. A. Khayam et al., “Performance analysis and modeling of errors and losses over 802.11b LANs for high-bitrate real-time multimedia”, Signal Process. Image Communication, vol. 18, no. 7, pp. 575-595, August 2003 for further details of data collection.

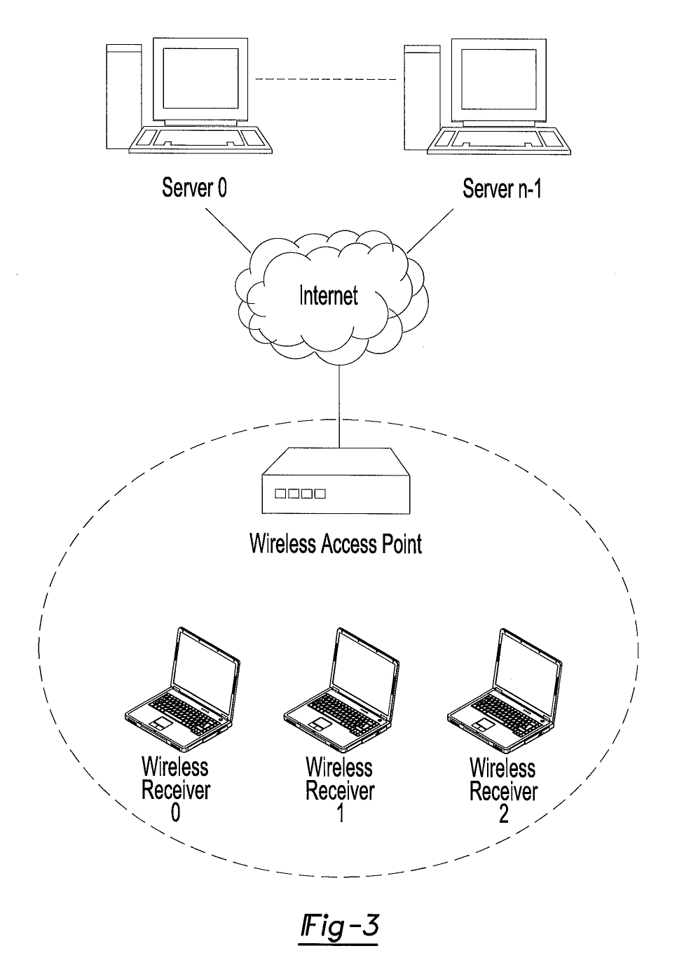

The 802.11b network outlined in FIG. 3 was assumed for simulation setup. The setup consisted of up to twenty multimedia servers with IP addresses of well-known multimedia web servers. In order to quantify the worst-case performance, multiple source IP addresses from the same streaming subnet were used so that only a few bit-errors can map source IP address into another. Furthermore, it was assumed that all the streams were being received at only three wireless stations in the wireless LAN. The wireless receivers had IP addresses which were very close to each other so that a few bit-errors could have changed one destination IP address to another. Distinct source and destination ports were used for each multimedia stream.

The video streams used for the simulations were compressed using the H.264/JVT video encoder. Unless otherwise stated, all video streams have the same encoding bitrate. These equal bitrate multimedia streams render the least informative a priori distribution. Since all the streams have the same encoding bitrate, the amount of data transmitted over the network increases linearly with an increase in the number of multimedia streams. For each packet transmission i) 512 bytes were taken from a video stream as the packet payload, ii) UDP, IP and 802.11-MAC headers were appended to the payload, and iii) the resultant (header and payload) packet was corrupted using the bit-error traces. The video streams were assigned to the three wireless receivers in a round-robin manner, receiver 0→stream0, receiver1→stream 1, receiver2→stream2, receiver0→stream4, up to stream 19. Transmission of packets from each stream was also simulated in a round robin fashion.

The following provides an evaluation of the throughputs provided by GSV and LSV at 2, 5.5, and 11 Mbps data rates of an 802.11b wireless LAN. Here, the term “throughput” refers to the ratio of the total number of packets correctly relayed to the wireless receiver's application and the total number of packets sent by the sender's application layer over a fixed period of time. Some of these packets will be corrupted, and therefore this throughput consists of both error-free and corrupted packets. Subsequent sections demonstrate that errors in corrupted packets can be corrected using much less FEC redundancy than the conventional UDP/IP/802.11 protocol stack. Unless otherwise stated, the bit-error probability of p=0.1 may be used and results are reported for receiver-0.

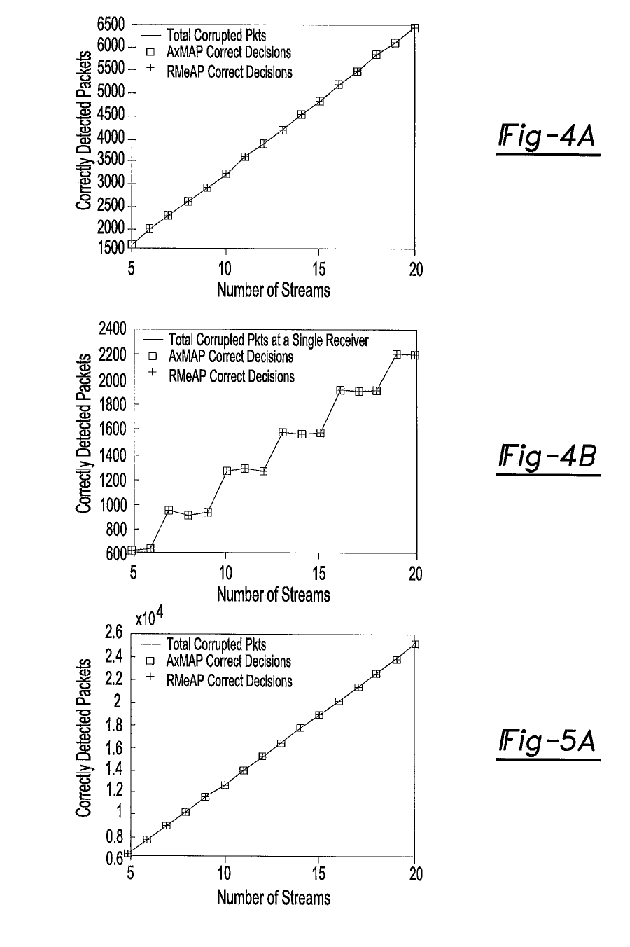

FIG. 4A outlines the performance of AxMAP and RMeAP detectors in conjunction with GSV at 2 Mbps. The dotted line in the figure provides the total number of corrupted packets; that is, the maximum number of corrupted packets that can be correctly detected and relayed to the receiver's application layer. It is clear from this figure that both Ax-MAP and RMeAP detectors have very high detection accuracies; for both detectors, more than 99% of received packets are correctly detected.

FIG. 4B shows the performance of the detectors in an LSV scenario. The LSV only focuses on packets destined for receiver-0, and therefore comparison with FIG. 4A shows that the total number of corrupted packets is always lesser than the GSV case. Also note that the performances shown in FIG. 4B are the sum of incorrect decisions (i.e., packets whose destination was not accurately ascertained) and missed packets (i.e., packets whose recovery was not attempted). It is easily observed from FIG. 4B that even in the LSV case both AxMAP and RMeAP detectors provide very accurate decisions; in all cases, more than 99% decisions are correct. Thus, although based completely on local statistics, the LSV renders performance comparable to that of GSV at 2 Mbps.

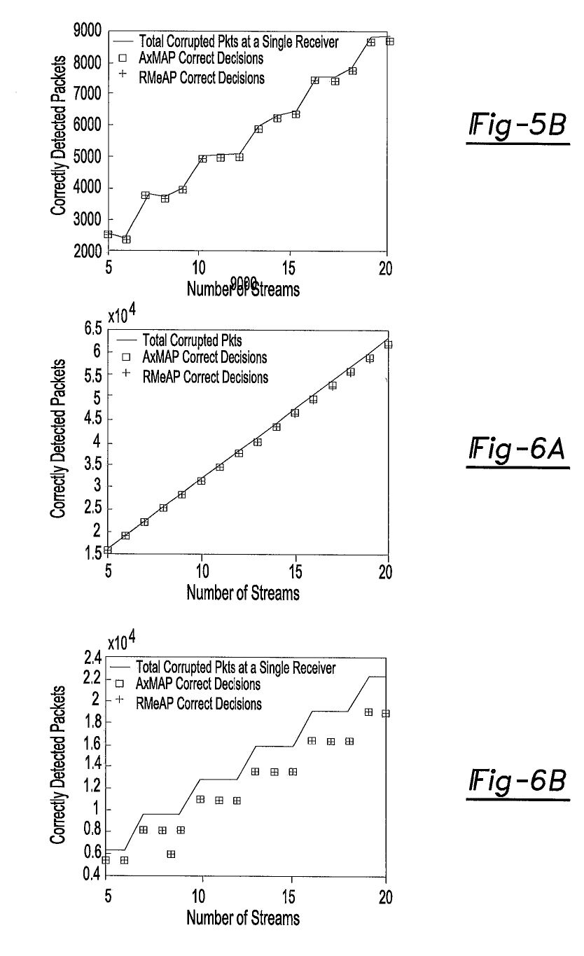

FIGS. 5A and 5B show the AxMAP and RMeAP detectors' throughputs at 5.5 Mbps. For GSV, the results are similar to the results at 2 Mbps since both AxMAP and REeAP detectors provide extremely accurate detection of corrupted packet headers; more than 99% of the packets are correctly detected. It has been shown that the error-free packet throughput at 5.5 Mbps is much lower than 2 Mbps. The results of FIG. 5A show that even for this somewhat high error-rate 5.5 Mbps channel, the AxMAP and RMeAP detectors render excellent performances in a GSV scenario.

The 5.5 Mbps LSV results given in FIG. 5B are also consistent with the 2 Mbps case as both AxMAP and RMeAP have very high detection accuracies. The overall LSV performance is slightly inferior to the 2 Mbps case, but more than 98% of the corrupted packets are detected correctly. Thus, the increased error-rate at 5.5 Mbps does not deteriorate the performance of the detectors under consideration.

FIG. 6A demonstrates that in a GSV scenario, both AxMAP and RMeAP detectors are very accurate for the high error-rate 11 Mbps channel. The GSV performances of AxMAP and RMeAP detectors are slightly worse than at 5.5 and 2 Mbps. This performance degradation is due to the increased error-rate. Nevertheless, 98% of the corrupted packets are detected correctly.

In FIG. 6B, the LSV detection performance at 11 Mbps shows a clear drop in the accuracy of both detectors; approximately 85% of the packets are correctly detected as opposed to more than 99% and 98% at 2 and 5.5 Mbps, respectively. This result is not very surprising because the percentage of error-free packets is approximately 15% at 11 Mbps as opposed to more than 64% and 99% at 5.5 and 2 Mbps. Due to the high error-rate at 11 Mbps, and due in part to the local nature of the variant under consideration, there are not enough error-free packets to build a robust a priori distribution. Nevertheless, keeping in view the view high error-rate at 11 Mbps, the LSV performance is still optimal because more than 85% of the packets are correctly detected for any number of streams.

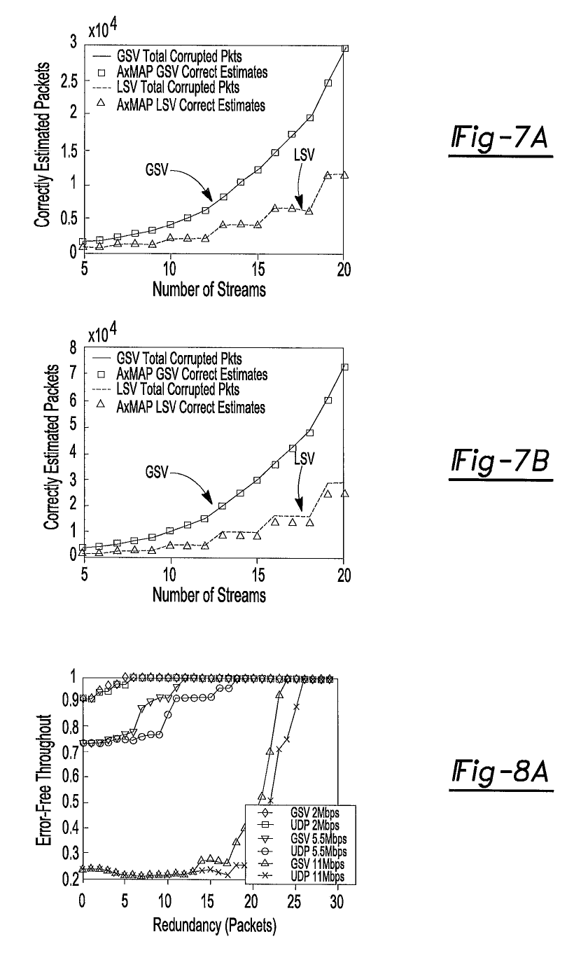

The foregoing establishes the efficacy of the proposed schemes for the case where the source bitrates of all received streams are equal. FIGS. 7A and 7B, illustrate the scenario where the source bitrates are skewed, with encoding bitrates varying from 50 Kbps to 1 Mbps. Accuracies of the AxMAP and RMeAP detectors were almost identical, therefore FIGS. 7A and 7B only show the AxMAP detector. Also, performance at 2 Mbps was similar and is skipped for brevity. It can be clearly observed that the throughput of the header detection scheme is very good at 11 and 5.5 Mbps. While LSV's performance is slightly inferior to GSV, both variants relay most of the corrupted packets to the application layer. Henceforth, all results employ the (worst-case) equal bitrates streams.

A packet that is not intended for a multimedia session, but gets relayed to that session represents a false positive. False positive rates of the AxMAP detector for the twenty streams case are given in Table I below.

| | 2 Mbps | 5.5 Mbps | 11 Mbps |
|---|---|---|---|
| GSV | 0.377% | 0.182% | 0.45% |
| LSV | 0.377% | 0.073% | 0.21% |

It can be observed that the false positive rates at all data rates are extremely low. While these false positives are almost negligible, they may desynchronize video and FEC decoders. Thus, it is important to detect the false positives. To this end, when using JVT/H.264 based encoding one can have a single slice per packet, with the slice sequence numbers protected with enough redundancy to ensure that these sequence numbers can always be recovered at the receiver. A receiver can then drop all packets whose slice numbers are much larger or smaller than the next/expected slice number. For video encoders that do not have a slice/packet sequence number, a small incremental packet sequence number with parity bytes can be inserted into each packet by the sender's application layer. This sequence number based scheme can also provide erasure locations (i.e., dropped packets) to the FEC decoder.

The high throughputs rendered by LSV and GSV contain corrupted data and it is important to ascertain how much redundancy will be required to correct the erroneous bits within the corrupted packets. Similarly, in order to draw a fair comparison it is important to compare the FEC redundancy of the proposed schemes with a similar FEC scheme deployed on an application running on the conventional UDP/IP/802.11-MAC protocol stack. The next section provides this comparison.

The previous section focused on techniques to relay maximum amount of error-free and corrupted multimedia data to a wireless application. This section evaluates the amount of FEC redundancy required by the multimedia application to correct errors in the corrupted multimedia content. The FEC redundancies of GSV and LSV are compared with the redundancy required to recover from losses if a conventional UDP/IP/802.11-MAC protocol stack is employed at the receiver. The analysis reports only the results for the AxMAP detector because both AxMAP and RMeAP detectors relay approximately the same number of corrupted packets to the application.

Due to header detection, some of the packets reaching the application layer have errors, while some other packets are lost due to missed or inaccurate detections. Missing bytes due to lost packets may be considered as erasures in an FEC codeword. Thus, an FEC scheme operating over LSV and GSV should be able to decode errors and erasures simultaneously.

One may employ a block-based systematic Reed-Solomon (RS) codes for FEC-based recovery. For error correction, if a code-word has r number of redundant symbols then a maximum of [r/2] transmission errors into that block can be corrected. No error can be corrected if the number of transmission errors in a block is great than [r/2]. Many contemporary FEC schemes have been designed for and applied to erasure recovery, where knowledge of error locations facilitates FEC decoding. If a codeword has a redundancy of r then a maximum of r erasures can be recovered. Thus, in the present scenario, where both errors and erasures are observed, the data recovery and correction is bounded by r≧2q+m, where q is the number of errors and m is the number of erasures. For the UDP/IP/802.11 protocol stack, one may employ RS erasure decoding to recover dropped packets. For LSV and GSV, one may use a variant of the RS coding that is capable of joint error and erasure recovery.

The following section shows FEC results for a packet block length of N=30. The FEC scheme is systematic and hence a packet block can be segregated into message packets and redundant packets. Each FEC codeword is composed of four bytes from a different packet, where each packet consists of 512 bytes. Thus, each packet contributes to 128 separate FEC codewords, and each codeword spans over 30 packets. Thus, while the packet block-length is 30 packets, the code-length is 120 bytes (or 120 symbols where each symbol is drawn from a Galois field GF(2⁸). The results presented for the above FEC parameters are representative of performance trends that were observed for a wider range of packet block lengths, code lengths and packet sizes.

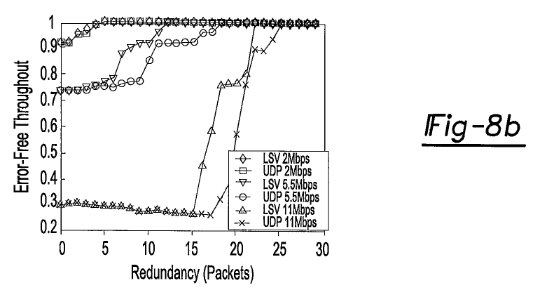

FIGS. 8A and 8B compare the FEC redundancies of GSV and LSV, respectively, to the conventional UDP/IP/802.11-MAC protocol stack. It can be clearly seen that for all data rates the conventional schemes require a higher amount of redundancy to provide 100% reliability when compared with the proposed header detection variants. It can be observed from the figures that the FEC performances of GSV and LSV improve with respect to an increase in the 802.11b data rate. This is congruent with the preceding discussions where the observed error-rate at 2 Mbps is quite low and therefore error recovery does not require much redundancy. The FEC redundancy subsequently increases at 5.5 and 11 Mbps, and the performance gap between header detection and the conventional protocol stack widens.

Here it is noteworthy that due to their enhanced error resilience features, emerging real-time applications can tolerate a certain level of losses in the multimedia content. Thus, often in video streaming if the underlying source coding is error-resilient then the aim of the FEC scheme is to keep the number of losses under a tolerable threshold instead of attempting 100% data recovery. Consequently, it is important to compare the relative performance of the conventional and proposed schemes even over the region where neither conventional UDP/IP/802.11 nor GSV/LSV provides 100% reliability. In this context, the utility of the proposed schemes can be further appreciated by noting that the throughputs of the proposed schemes are equal to or better than the conventional protocol stack for all redundancies.

In another aspect of this disclosure, the header estimation module, instead of relying on a priori CHF distribution from correctly-received packets, uses likelihood functions which take into account a model for the channel over which data packets have been received at the receiver. Specifically, header estimation likelihood functions are derived for two important classes of MAC layer channel models, namely the full-state Markov (FSM) model and the multifractal wavelet model (MWM). Let Λᵢ={xᵢ₁, xᵢ₂, . . . , x_{iN}} denote an ordered set of N critical header fields for an arbitrary multimedia session i. The simulations discussed in this disclosure use N=5, where xᵢ₁, xᵢ₂, xᵢ₃, xᵢ₄, and xᵢ₅ correspond to the destination MAC, source IP, destination IP, source port, and destination port of multimedia session i, respectively. A receiver receives M≧1 simultaneous multimedia streams. Let Ω={Λ₁, Λ₂, . . . , Λ_{M}} denote an unordered set of CHF each corresponding to a currently active multimedia sessions on a given receiver. Note that each Λᵢ={xᵢ₁, xᵢ₂, . . . , x_{iN}}εΩ is in turn a set of critical fields corresponding to a given session, where the first subscript of x is the session index and the second subscript is the CHF index. Let \tilde{Λ}ᵣ denote the set of CHF of a received packet, i.e. \tilde{Λ}ᵣ={\tilde{x}ᵣ₁, \tilde{x}ᵣ₂, . . . , \tilde{x}_{rN}} is a possibly corrupted version of an ΛᵢεΩ. \hat{Λ}ᵣ denotes the estimated CHF.

Let X represent a stochastic MAC layer channel model characterizing the bit-error channel over which a receiver is receiving it packets. Then, for a critical header field xᵢⱼ (i.e., critical field j for a multimedia session i), our objective is to derive the likelihood function Pr{\tilde{x}ᵣⱼ|xᵢⱼ,X} in terms of the parameters of X. In other words, given parameters of a channel model X, it may be desirable to find the likelihood that a transmitted critical header field xᵢⱼ (after possible channel corruptions) was received as \tilde{x}ᵣⱼ. It may be assumed that the likelihood functions of all CHF are independent. Thus, Pr{\tilde{x}ᵣⱼ|xᵢⱼ, X}'s for each critical field can be ascertained independently and then the overall likelihood considering all critical fields is:

$$Pr \{ {\tilde{Λ}}_{r} \vert {Λ}_{i} , X \} = {\prod }_{j = 1}^{N} Pr \{ {\tilde{x}}_{ij} \vert {x}_{ij} , X \} \qquad ( 4 )$$

where 1≦i≦M is the session index and j is the CHF index. Once Pr{\tilde{Λ}ᵣ|Λᵢ,X} has been computed for all 1≦i≦M, the CHF estimate \hat{Λ}ᵣ is simply the Λᵢ that renders the maximum Pr{\tilde{Λ}ᵣ|Λᵢ,X}.

Errors and losses over many contemporary wireless channels have been shown to be Markov in nature. These channels are modeled using full-state Markov (FSM) chains, a very important class of wireless channel models.

Given that an FSM chain in state vᵢ can only transit to two FSM states, 2vᵢ+0 or 2vᵢ+1; all FSM states are mod 2^{k}. Thus, when the bit added to 2vᵢ is zᵢ[k+1](the bit at the k+1-st location of zᵢ), the FSM chain transits to state vᵢ→2vᵢ+zᵢ[k+1]. From state 2vᵢ+zᵢ[k+1], the process will transit to 2(2vᵢ+zᵢ[k+1])+zᵢ[k+2]=4vᵢ+2zᵢ[k+1]+zᵢ[k+2]. Using similar logic, the process will next transit to

2(4vᵢ+2zᵢ[k+1]+zᵢ[k+2])+zᵢ[k+3]=8vᵢ+4zᵢ[k+1]+2zᵢ[k+2]+zᵢ[k+3].

Generalizing this notion yields the following recursive multiplicative expression for the FSM likelihood function:

$$Pr \{ {\tilde{x}}_{r} \vert {x}_{i} , {X}_{n} \} = {π}_{vi} Pr \{ {v}_{i} -> ( 2 {v}_{i} + {z}_{i} [ k + 1 ] \\ {\prod }_{a = 2}^{W - k - 1} Pr \{ \begin{matrix}( {2}^{a - 1} {v}_{1} + {\sum }_{b = 0}^{a - 2} {2}^{a - 1 - b} {z}_{i} [ k + 1 + b ] ) \\ ↓ \\ ( {2}^{a} {v}_{i} + {\sum }_{b = 0}^{a - 1} {2}^{a - 1 - b} {z}_{i} [ k + 1 + b ] )\end{matrix} \} , \qquad ( 6 )$$

where all state indices are mod 2^{k}, n is the bit time index, W represents the number of bits into the critical field, πₓ represents the steady-state probability of being in FSM state x, and Pr{x→y} is the transition probability of going from FSM state x to state y.

The FSM likelihood function given above answers the following question: What is the probability that channel errors have changed xᵢ to \tilde{x}ᵣ? Since zᵢ=\tilde{x}ᵣ⊕xᵢ denotes the bit pattern that would be observed if the channel changed xᵢ to \tilde{x}ᵣ, the probability that the channel Xₙ produced the bit-error pattern zᵢ should be determined. Clearly, the FSM channel's initial state should be vᵢ where vᵢ denotes the FSM state represented by the first memory-window of zᵢ, leading to the πᵥ_{ᵢ} term. This initial state should be followed by a unique sequence of state transitions that result in the bit-error pattern zᵢ. To quantify the probability that an FSM channel will follow this “unique state sequence”, recall that in one transition the FSM process can only transit to two possible states. Also, due to the well-known Markov property, the probability of transiting to one of the two possible states is only dependent on the present state. The final likelihood score of xᵢ is hence characterized by a multiplication of the transition probabilities of this unique state sequence, as represented by the multiplicative Pr{x→y} terms in the likelihood function.

A new class of folded Markov chains (FMCs) which aggregate similar FSM states to create a lumped process is derived below. Let the state space of an FSM with 2^{k} states be given as H={0, 1, . . . , 2^{k}−1}, where k is the FSM memory-length. Now consider a new lumped process with state space S={S₀, S₁, . . . , S_{N-1}}, where N≦2^{k} To create a lumped process, FSM states are partitioned and each partition is aggregated into a state of the lumped process. The following proves the following necessary condition for defining partitions of the FSM state space:

Lemma 1: The next state in an aggregate process can be accurately determined only if the FSM states (2ᵢ) mod 2^{k} and (2i+1) mod 2^{k} do not belong to the same aggregate state,

(2i)mod 2^{k}εSⱼ [symbol] (2i+1)mod 2^{k}∉Sⱼ,

where k is the memory-length, iεH and SⱼεS.

Proof: This lemma implies that both transition possibilities of an FSM state cannot be aggregated in a single state. Let there exist an aggregate state Sⱼ that contains both FSM states 2i and 2i+1, and let Sq be an aggregate state containing state i. Then, Pr{S_{q}→Sⱼ} does not give any information about whether a good- or a bad-bit should be added to the memory-window.

The strong lumpability theorem asserts that all FSM states belong to an aggregate state. It is unlikely that FSM chains trained using actual wireless traces will satisfy this condition. Therefore, an FSM chain's state transition probabilities is modified such that the modified chain can be divided into two equal-sized partitions that satisfy the strong lumpability condition.

It is noted that to reach FSM states 2i and 2i+1 for 0≦i≦2^{k-1}−1 in a single transition, the current state of the FSM chain should be either state i or state (2^{k-1}+i). In other words, the following pairs of FSM states have the same set of next possible states: (0, 2^{k-1}), (1, 1+2^{k-1}), . . . , (2^{k-1}−1, 2^{k-1}=2^{k}−1). Based on the observation that the state pair (i, 2^{k-1}+i) have the same one-step transition possibilities, It is proposed to modify an FSM chain's transition probabilities matrix as follows:

$$\begin{matrix}{\hat{p}}_{i ( 2 i ) mod {2}^{k}} = {\hat{p}}_{{2}^{k - {1}_{+ i , ( 2 i ) mod {2}^{k}}}} \\ = \frac{{p}_{i ( 2 i ) mod {2}^{k} + {p}_{2}^{k - 1} + i ( 2 i ) mod {2}^{k}}}{2}\end{matrix}$$

$$and$$

$${\hat{p}}_{i , ( 2 i + 1 ) mod {2}^{k}} = {\hat{p}}_{{2}^{k - 1 - i , {( 2 i + 1 )}_{mod {2}^{k}}}} = 1 - {\hat{p}}_{i , ( 2 i ) mod {2}^{k}}$$

For i=0, 1, . . . , 2^{k}−1, where p_{i,j} and \hat{p}_{i,j} represent the transition probabilities of the original and modified FSM chains. After this transformation, state pairs (i, 2^{k-1}+i) in the modified transition probability matrix clearly satisfy the lumpability constraint and can be aggregated together.

Using the above strategy, any 2^{k}×2^{k} FSM transition probability matrix can be modified and folded about 2^{k-1} to give a Markov chain with exactly half the number of states. Since the basic transition probability structure is retained after the folding operation, this state reduction procedure can in fact be applied recursively to a 2^{k} state FSM chain to give a 2^{m} state folded Markov chain, where m is an integer such that 1≦m≦k. These models are referred to as folded Markov chains (FMCs). A folded process is a coarse on-average approximation of an FSM chain because folding simply ensures a non-zero transition probability between two aggregate states.

Using the FMC state aggregation procedure, any 2^{k} state FSM chain can be reduced to a 2^{m} state Markov chain, where m<k. The FSM chain likelihood function given above in (6) can be easily extended to the FMCs because FMCs retain the inherent structure of the FSM transition probability matrix, i.e., each row of the FMC transition probability matrix has only two non-zero entries in each row. Thus, using (6) the likelihood function for an order-m FMC can be rewritten as:

$$Pr \{ {\tilde{x}}_{r} \vert {x}_{i} , {X}_{n} \} = {π}_{{S}_{vi}} Pr \{ {S}_{{v}_{i}} -> {S}_{2 {v}_{i} + {z}_{i} [ k + 1 ]} \}$$

$${\prod }_{a = 2}^{W - m - 1} Pr \{ \begin{matrix}\begin{matrix}( {S}_{{2}^{a - {1}_{{v}_{i} +} {\sum }_{b = 0}^{a - 2} {2}^{a - 1 - {b}_{{z}_{i} [ k + 1 + b ]}}}} ) \\ ↓\end{matrix} \\ ( {S}_{2} {a}_{{v}_{i} + {\sum }_{b = 0}^{a - 1} {2}^{a - 1 - {b}_{{z}_{i} [ k + 1 + b}}} )\end{matrix} \} ,$$

where the subscripts of all aggregate FMC states Sₓ are modulo 2^{m} and all other parameters are defined in equation (6). The low-complexity of FMCs makes them a natural alternative to FSM chains in the present header estimation methodology.

In this section, the CHF likelihood function for a k-th order FSM chain Xₙ is derived, where n is the bit time index. By fixing the CHF index j, the focus may be on one arbitrary critical field xᵢⱼεΛᵢ. Henceforth xᵢ and \tilde{x}ᵣ respectively represent the critical field j from Λᵢ and the received critical field j. Let us define a new variable:

zᵢ=\tilde{x}ᵣ⊕xᵢ, (5)

where ⊕ represents a binary XOR operation. zᵢ comprises bit locations that are different between \tilde{x}ᵣ and xᵢ. Assuming that the difference bits are in fact the errors introduced by FSM channel, Pr{\tilde{x}ᵣ|xᵢ,Xₙ} is the likelihood of observing error pattern zᵢ on the channel.

The multifractal wavelet model (MWM) captures self-similar and long-range-dependent network phenomena. MWM uses expectation-maximization to model two random variables: (i) the scaling coefficient at the coarsest scale Uⱼ_{₀}_{,k}_{₀}, where j₀ and k₀ represent the coarsest scale and time, respectively; (ii) A_{j,k} random variables defined over a [−1, 1] interval, j and k representing the scale and time, respectively. It has been shown that the 11 Mbps bit-errors have long-range dependence, which can be captured using the MWM. The number of bit-errors in a packet were used as the training sequence for the MWM.

It was also shown that due to the use of the Haar wavelet transform, the MWM-predicted number of errors e[n] in packet n can be expressed as e[n]=2^{-j/2}U_{j,k} for n=0, 1, . . . , 2^{j-1}. If the packets have a fixed size C, then the probability of bit-errors in the packet received at packet time index n is p[n]=e[n]/C=2^{-j/2}U_{j,k}/C. Now note that each received bit is basically a value taken from a binary time series of length l, i.e., {x[i]}ᵢ₌₀^{l}, x[i]ε{0,1}, and i represents the discrete bit time index. Based on equation (5),

$${\sum }_{a = 1}^{W} {z}_{i} [ a ]$$

yields the total number of bits that are different between \tilde{x}ᵣ and xᵢ, i.e., the hamming distance between \tilde{x}ᵣ and xᵢ. If the bits of zᵢ are in fact the errors introduced by a MWM wireless channel then given a probability of having

$${\sum }_{a = 1}^{W} {z}_{i} [ a ]$$

errors is

$${( p [ n ] )}^{{\sum }_{a = 1}^{W} {z}_{i} [ a ]} ,$$

and the probability of having

$$W - {\sum }_{a = 1}^{W} {z}_{i} [ a ]$$

corrects bits is

$${( 1 - p [ n ] )}^{W - {\sum }_{a = 1}^{W} {z}_{i} [ a ]} .$$

Likelihood of the bit pattern zᵢ is then a multiplication of the above events. Thus, for a critical header field \tilde{x}ᵣ received over a MWM channel Xₙ, the likelihood of a known critical header field xᵢ corresponding to session i is

$$Pr \{ {\tilde{x}}_{r} \vert {x}_{i} , {X}_{n} \} = {( \frac{{2}^{- j / 2} {U}_{j , k}}{C} )}^{{\sum }_{a = 1}^{W} {z}_{i} [ a ]} {( 1 - \frac{{2}^{- j / 2} {U}_{j , k}}{C} )}^{W - {\sum }_{a = 1}^{W} {z}_{i} [ a ]} \qquad ( 7 )$$

where n=0, 1, . . . , 2^{j-1} is the packet time index, j is the number of scales used to train the MWM, C is the number of bits in a packet, W is the number of bits of in the critical field, and U_{j,k} is the scaling coefficient at scale j and level k.

Similar to (6), the MWM likelihood function renders the probability that the bit-error pattern zᵢ=\tilde{x}ᵣ⊕xᵢ is observed on an MWM channel. In the above derivation, the probability of bit-error in packet n was given by 2^{-j/2}U_{j,k}/C. Thus the probability of observing

$${\sum }_{a = 1}^{W} {z}_{i} [ a ]$$

bit-errors in packet n is

$${( p [ n ] )}^{{\sum }_{a = 1}^{W} {z}_{i} [ a ]} = {( {2}^{- j / 2} {U}_{j , k} / C )}^{{\sum }_{a = 1}^{W} {z}_{i} [ a ]} .$$

Treating error-free and corrupted bits as the two outputs of a Bernoulli random variable yields the MWM likelihood expression.

Once Pr{\tilde{x}ᵣ|xᵢ,Xₙ}'s for all currently active sessions, 1≦i≦M, are computed using the FSM or MWM likelihood functions, the session i that renders maximum Pr{\tilde{Λ}ᵣ|Λᵢ,X} is chosen as the estimated CHF, \hat{Λ}ᵣ. One may also introduce a provision that if the most maximum-likelihood is less 0.25 then the packet is dropped since the estimation confidence is very low.

The complexity of an MWM to generate a length l sequence is linear. However, the complexity of FSM chains grows exponentially with respect to memory-length. Such exponential complexity of FSM chains requires very high computational power and memory at the receiver, both scarce resources in complexity- and power-constrained wireless environments. Thus, FSM chains in their present form are unreasonably complex to be employed in the header estimation framework on resource-constrained wireless devices.

The number of multimedia sessions on a receiver is a function of the multimedia application. If the number of multimedia sessions is small, a simple estimator—using, for example, a distance measure with a memory-less channel assumption—should be sufficient. The likelihood functions derived in previous sections are merely exemplary in nature, detailing how different channel models can be leveraged for header estimation.

The cost of using a channel model for ML header estimation is incurred in terms of the model's training complexity. Both MWM and FMC have linear complexity with respect to the training data. For stationary channels, this training has to be done only once and hence does not pose a complexity issue. As a final comment, note that the header estimation methodology does not require any hardware modifications. Thus header estimation can be easily implemented on an open-source protocol stack. Even for a closed-source protocol stack, the proposed modules can be implemented by opening a raw socket on the link layer and implementing a simple packet processor above the socket

The above description is merely exemplary in nature and is not intended to limit the present disclosure, application, or uses.

What is claimed is:

1. A method for estimating the header of a data packet in a wireless communication system, comprising:
maintaining a list of data packets received without an error at a receiver;
receiving at the receiver a corrupt data packet having errors in its header;
computing a likelihood score for the header of the corrupt data packet in relation to each entry in the list of data packets; and
estimating the header for the corrupt data packet based on the plurality of likelihood scores.

2. The method of claim 1 further comprises identifying critical fields in the header that uniquely classify a multimedia session and computing the likelihood score for the critical field of the header.

3. The method of claim 2 wherein the critical fields in the header are further defined as destination media access control address, source IP addresses, destination IP addresses, source port identifier, and destination port identifier.

4. The method of claim 1 further comprises building the list of data packets only using data packets intended for the receiver.

5. The method of claim 1 further comprises computing a likelihood score based on a Hamming distance between the header of the corrupt data packet and each entry in the list of data packets.

6. The method of claim 1 further comprises performing the steps of header estimation at a layer of the receiver below an application layer as defined by an Open System Interconnection (OSI) model.

7. The method of claim 1 further comprises replacing the header of the corrupt data packet with the estimated header and forwarding the corrupt data packet to an application layer within the receiver.

8. The method of claim 1 further comprises selecting an entry having a highest likelihood score as an estimated header for the corrupt data packet.

9. The method of claim 1 further comprises determining a mean of a posteriori density and selecting an entry in the list of data packets closest to the mean as the an estimated header for the corrupt data packet.

10. A method for estimating the header of a data packet in a wireless communication system, comprising:
maintaining a list of data packets received without an error at a receiver;
modeling a channel over which data packets are received at the receiver;
deriving a likelihood function which uses input from the channel model;
receiving at the receiver a corrupt data packet having errors in its header;
computing a likelihood score for the header of the corrupt data packet in relation to each entry in the list of data packets using the derived likelihood function; and
estimating the header for the corrupt data packet based on the plurality of likelihood scores.

11. The method of claim 10 further comprises identifying critical fields in the header that uniquely classify a multimedia session and computing the likelihood score for the critical field of the header.

12. The method of claim 11 wherein the critical fields in the header are further defined as destination media access control address, source IP addresses, destination IP addresses, source port identifier, and destination port identifier.

13. The method of claim 11 further comprises building the list of data packets only using data packets intended for the receiver.

14. The method of claim 10 further comprises modeling the channel using full-state Markov channels.

15. The method of claim 14 further comprises defining the likelihood function as
$$Pr \{ {\tilde{x}}_{r} \vert {x}_{i} , {X}_{n} \} = {π}_{vi} Pr \{ {v}_{i} -> ( 2 {v}_{i} + {z}_{i} [ k + 1 ] \\ {\prod }_{a = 2}^{W - k - 1} Pr \{ \begin{matrix}\begin{matrix}( {2}^{a - 1} {v}_{1} + {\sum }_{b = 0}^{a - 2} {2}^{a - 1 - b} {z}_{i} [ k + 1 + b ] ) \\ ↓\end{matrix} \\ ( {2}^{a} {v}_{i} + {\sum }_{b = 0}^{a - 1} {2}^{a - 1 - b} {z}_{i} [ k + 1 + b ] )\end{matrix} \}$$
where all state indices are mod 2^{k}, n is a bit time index, W represents a number of bits into the header, πₓ represents the steady-state probability of being in full-state Markov (FSM) state x, and Pr{x→y} is the transition probability of going from FSM state x to state y.

16. The method of claim 10 further comprises modeling the channel using a multifractal wavelet model.

17. The method of 16 further comprises defining the likelihood function as
$$Pr \{ {\tilde{x}}_{r} \vert {x}_{i} , {X}_{n} \} = {( \frac{{2}^{- j / 2} {U}_{j , k}}{C} )}^{{\sum }_{a = 1}^{W} {z}_{i} [ a ]} {( 1 - \frac{{2}^{- j / 2} {U}_{j , k}}{C} )}^{W - {\sum }_{a = 1}^{W} {z}_{i} [ a ]}$$
where n=0, 1, . . . , 2^{j-1} is a packet time index, j is a number of scales used to train a multifractual wavelet model, C is a number of bits in a packet, W is a number of bits of in critical fields of the header, and U_{j,k} is the scaling coefficient at scale j and level k.

18. The method of claim 10 further comprises selecting an entry having a highest likelihood score as an estimated header for the corrupt data packet.

19. The method of claim 10 further comprises determining a mean of a posteriori density and selecting an entry in the list of data packets closest to the mean as the an estimated header for the corrupt data packet.

20. The method of claim 10 further comprises performing the steps of header estimation at a layer of the receiver below an application layer as defined by an Open System Interconnection (OSI) model.

21. The method of claim 10 further comprises replacing the header of the corrupt data packet with the estimated header and forwarding the corrupt data packet to an application layer within the receiver.
